(19) United States
(12) Patent Application Publication
(10) Pub. No.: US 2026/0210301 A1
(43) Pub. Date: Jul. 23, 2026

(54) HYDROGEN/AMMONIA MIXED COMBUSTION SYSTEM, MIXED COMBUSTION CONTROL DEVICE, AND MIXED COMBUSTION CONTROL METHOD

(71) Applicant: MITSUBISHI HEAVY INDUSTRIES, LTD., Tokyo (JP)

(72) Inventors: Takashi Sonoda, Tokyo (JP); Hirotoshi Matsumoto, Tokyo (JP); Teruyuki Okazaki, Tokyo (JP); Yukihiko Inoue, Tokyo (JP)

(73) Assignee: MITSUBISHI HEAVY INDUSTRIES, LTD., Tokyo (JP)

(21) Appl. No.: 19/140,542

(22) PCT Filed: Sep. 28, 2023
(86) PCT No.: PCT/JP2023/035467

§ 371 Date: Jun. 18, 2025

(30) Foreign Application Priority Data
Feb. 9, 2023 (JP) 2023-018304

(51) Int. Cl. F02D 41/00; F02C 9/40; F02D 41/02; F02D 41/24

(52) U.S. Cl. CPC F02C 9/40; F01N 3/08; F02C 7/22; F02D 19/0644; F02D 19/08; F02D 19/081; F02D 41/0027; F02D 41/027; F02D 41/2445; F02M 25/00; F01N 2570/10; F05D 2270/08; F05D 2270/20

(57) ABSTRACT

A mixed combustion system includes: a combustion device configured to mix and combust hydrogen or ammonia and fossil fuel; an exhaust gas after-treatment device configured to treat exhaust gas of the combustion device; and a mixed combustion control device configured to determine a mixed combustion ratio between the hydrogen or ammonia and the fossil fuel that are combusted by the combustion device and to control the combustion by the combustion device such that one or a plurality of predetermined variables are optimized. The one or the plurality of variables include at least one among an energy efficiency, an energy cost, and a carbon dioxide recovery efficiency.

### TECHNICAL FIELD

The present disclosure relates to a mixed combustion system, a mixed combustion control device, and a mixed combustion control method.

Priority is claimed to Japanese Patent Application No. 2023-018304, filed Feb. 9, 2023, the content of which is incorporated herein by reference.

### BACKGROUND ART

PTL 1 describes a system described below. That is, the system described in PTL 1 includes a gas turbine system. In addition, this gas turbine system includes a gas turbine; an after-treatment system configured to receive exhaust gas from the gas turbine system; and a control device. In addition, this control device is configured to: receive inputs; model operational behavior of an industrial plant based on the inputs, wherein the industrial plant includes the gas turbine and the after-treatment system; determine one or more operational parameter setpoints for the industrial plant; select the one or more operational parameter setpoints that reduce an output of a cost function; and apply the one or more operational parameter setpoints to control the industrial plant. In the system described in PTL 1, by generating setpoints for the gas turbine and the after-treatment system in real time, for example, to enhance efficiency or to reduce emissions, it is possible to stay in compliance for an extended period of time and provide catalyst health monitoring while reducing the fuel costs and lifetime operating costs for customers.

Incidentally, one of carbon dioxide (CO₂) emission reduction technologies is a technology of reducing CO₂ emissions by mixing and combusting fossil fuel and hydrogen or ammonia in an existing facility where fossil fuel is used. When fossil fuel and hydrogen or ammonia are mixed and combusted, it is required to perform an appropriate control including a mixed combustion ratio based on a difference in combustion characteristics between the fossil fuel and the hydrogen or ammonia. The combustion characteristics described below are, for example, the amount of heat generation, a combustion speed, and an exhaust gas composition, and affect performance of a combustion device or an exhaust gas treatment device.

### CITATION LIST

### Patent Literature

[PTL 1] U.S. Pat. No. 10,082,060

### SUMMARY OF INVENTION

### Technical Problem

The present disclosure has been made under the above-described circumstances, and an object thereof is to provide a mixed combustion system, a mixed combustion control device, and a mixed combustion control method where a mixed combustion ratio can be appropriately controlled.

### Solution to Problem

In order to achieve the above-described object, according to the present disclosure, there is provided a mixed combustion system including: a combustion device configured to mix and combust hydrogen or ammonia and fossil fuel; an exhaust gas after-treatment device configured to treat exhaust gas of the combustion device; and a mixed combustion control device configured to determine a mixed combustion ratio between the hydrogen or ammonia and the fossil fuel that are combusted by the combustion device and to control the combustion by the combustion device such that one or a plurality of predetermined variables are optimized, in which the one or the plurality of variables include at least one among an energy efficiency, an energy cost, and a carbon dioxide recovery efficiency.

According to the present disclosure, there is provided a mixed combustion control device, in which in a mixed combustion system including a combustion device configured to mix and combust hydrogen or ammonia and fossil fuel, and an exhaust gas after-treatment device configured to treat exhaust gas of the combustion device, a mixed combustion ratio between the hydrogen or ammonia and the fossil fuel that are combusted by the combustion device is determined and the combustion by the combustion device is controlled such that at least one among an energy efficiency, an energy cost, and a carbon dioxide recovery efficiency is optimized.

According to the present disclosure, there is provided a mixed combustion control method performed in a mixed combustion system including a combustion device configured to mix and combust hydrogen or ammonia and fossil fuel, and an exhaust gas after-treatment device configured to treat exhaust gas of the combustion device, the method including: determining a mixed combustion ratio between the hydrogen or ammonia and the fossil fuel that are combusted by the combustion device and controlling the combustion by the combustion device such that at least one among an energy efficiency, an energy cost, and a carbon dioxide recovery efficiency is optimized.

### Advantageous Effects of Invention

With the mixed combustion system, the mixed combustion control device, and the mixed combustion control method according to the present disclosure, the mixed combustion ratio can be appropriately controlled.

### BRIEF DESCRIPTION OF DRAWINGS

FIG. 1 is a block diagram illustrating a configuration example of a mixed combustion system according to an embodiment of the present disclosure.

FIG. 2 is a block diagram illustrating a configuration example of a trained machine learning model according to the embodiment of the present disclosure.

FIG. 3 is a block diagram illustrating another configuration example of the trained machine learning model according to the embodiment of the present disclosure.

FIG. 4 is a block diagram illustrating still another configuration example of the trained machine learning model according to the embodiment of the present disclosure.

FIG. 5 is a flowchart illustrating an operation example of a mixed combustion control device according to the embodiment of the present disclosure.

FIG. 6 is a schematic block diagram illustrating a configuration of a computer according to the embodiment of the present disclosure.

### DESCRIPTION OF EMBODIMENTS

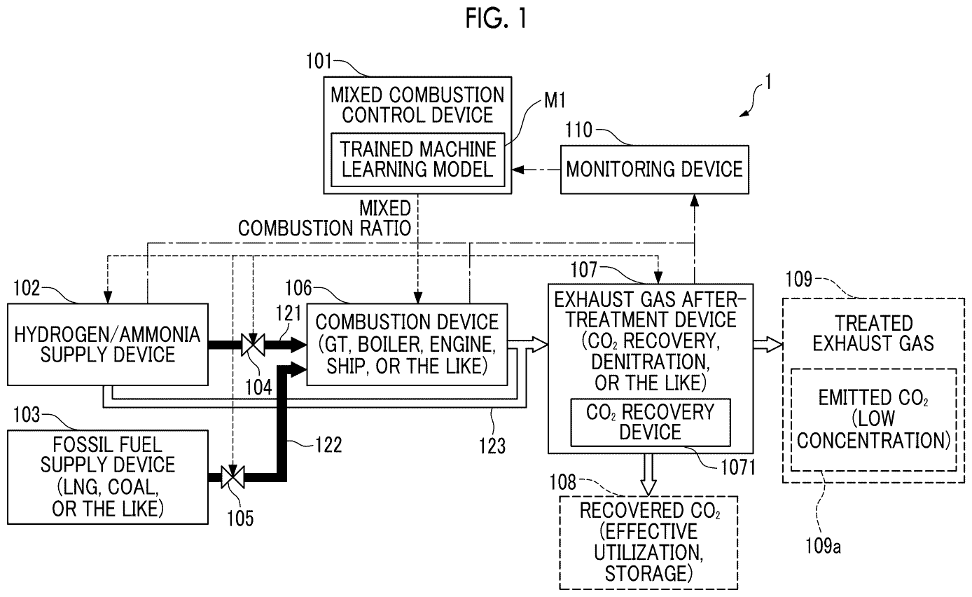

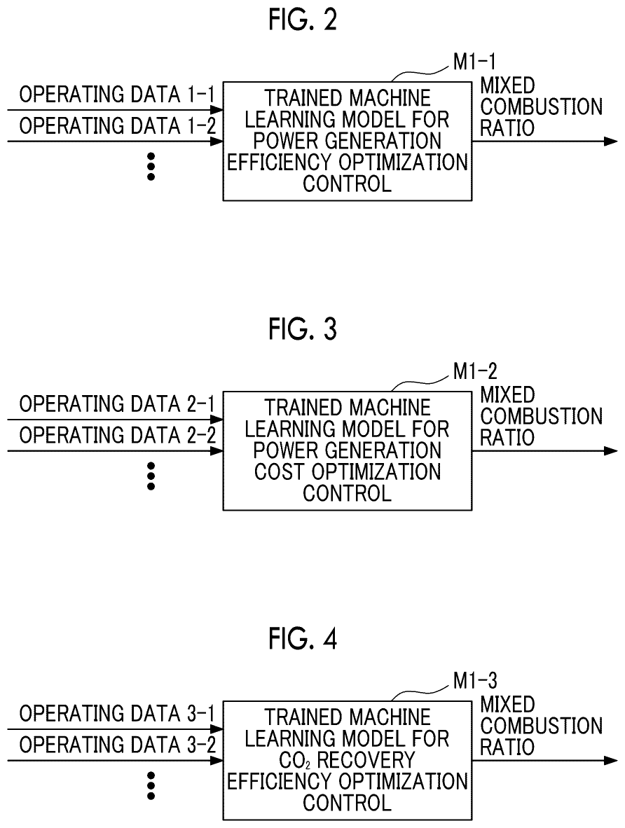

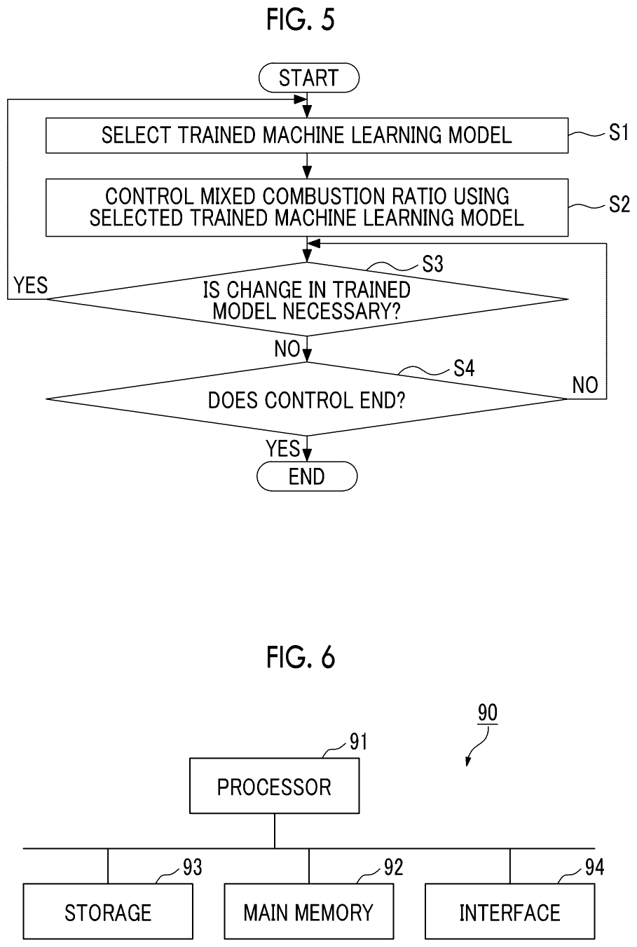

Hereinafter, a mixed combustion system, a mixed combustion control device, and a mixed combustion control method according to an embodiment of the present disclosure will be described with reference to FIGS. 1 to 6. FIG. 1 is a block diagram illustrating a configuration example of the mixed combustion system according to the embodiment of the present disclosure. FIGS. 2 to 4 are block diagrams illustrating a configuration example of a trained machine learning model according to the embodiment of the present disclosure. FIG. 5 is a flowchart illustrating an operation example of the mixed combustion control device according to the embodiment of the present disclosure. FIG. 6 is a schematic block diagram illustrating a configuration of a computer according to the embodiment of the present disclosure. In each drawing, the same reference numerals will be assigned to the same or corresponding configurations, and description thereof will be omitted as appropriate.

### Mixed Combustion System

As illustrated in FIG. 1, a mixed combustion system 1 according to the embodiment of the present disclosure includes, for example, a mixed combustion control device 101, a hydrogen/ammonia supply device 102, a fossil fuel supply device 103, valves 104 and 105, a combustion device 106, an exhaust gas after-treatment device 107, and a monitoring device 110. In FIG. 1, a black arrow indicates a flow of fuel, a white arrow indicates a flow of exhaust gas, a broken line arrow indicates a flow of a control signal or the like, and a chain line arrow indicates a flow of a sensor signal or the like. The mixed combustion system 1 is installed in, for example, a facility such as a plant or a moving body such as a ship. Hereinafter, as necessary, a case where the mixed combustion system 1 is a power generation plant and the combustion device 106 is a gas turbine (GT) power generation device will be described as an example.

The hydrogen/ammonia supply device 102 supplies hydrogen or ammonia (fuel ammonia) 121 to the combustion device 106 through the valve 104. The hydrogen/ammonia supply device 102 includes, for example, a hydrogen production device, a hydrogen storage tank, an ammonia production device, and an ammonia storage tank (storage device). The hydrogen/ammonia supply device 102 can be a device for supplying only hydrogen, a device for supplying only ammonia, or a device for supplying hydrogen and ammonia.

The fossil fuel supply device 103 supplies fossil fuel 122 such as LNG (liquefied natural gas) or coal to the combustion device 106 through the valve 105. The fossil fuel supply device 103 includes, for example, a storage device of the fossil fuel.

The combustion device 106 includes, for example, one or more among a gas turbine (GT), a boiler, a power generation engine, and a marine engine, and mixes and combusts the hydrogen or ammonia 121 supplied from the hydrogen/ammonia supply device 102 and the fossil fuel 122 supplied from the fossil fuel supply device 103. Note that, in the present embodiment, when a specific example is described, as described above, a case where the combustion device 106 is a gas turbine power generation device including a gas turbine and a generator that is driven by the gas turbine will be described as an example as necessary.

Exhaust gas 123 including exhaust gas emitted from the combustion device 106 and exhaust gas emitted from the hydrogen/ammonia supply device 102 is input to the exhaust gas after-treatment device 107. Note that, when the hydrogen/ammonia supply device 102 does not emit exhaust gas (for example, when hydrogen or ammonia is produced by the hydrogen or ammonia production device that does not emit exhaust gas) or does not include the hydrogen or ammonia production device, the hydrogen/ammonia supply device 102 does not emit exhaust gas.

The exhaust gas after-treatment device 107 includes, for example, a CO₂ recovery device 1071, a denitration device, or a desulfurization device, and recovers CO₂ using the CO₂ recovery device 1071, removes a nitrogen oxide, or removes sulfur content from the input exhaust gas 123. Hereinafter, for example, a case where the exhaust gas after-treatment device 107 includes the CO₂ recovery device 1071 will be described. The exhaust gas after-treatment device 107 does not need to include the CO₂ recovery device 1071. The CO₂ (108) recovered by the exhaust gas after-treatment device 107 is effectively utilized or is stored without being emitted to the atmosphere. On the other hand, the treated exhaust gas (109) that is treated by the exhaust gas after-treatment device 107 is emitted to the atmosphere through, for example, a chimney. The treated exhaust gas (109) includes CO₂ (109a) at a low concentration.

The monitoring device 110 acquires, for example, a sensor signal indicating a predetermined physical amount measured 1 using various sensors in the hydrogen/ammonia supply device 102, the combustion device 106, the exhaust gas after-treatment device 107, and the like, a control signal indicating a control state such as combustion characteristics or a target output, a control order, or the like, a calculated value such as an output, an efficiency, or a CO₂ recovery efficiency calculated based on the sensor signal and the like (hereinafter, the sensor signal, the control signal, and the calculated value will be collectively referred to as the operating data), and outputs the operating data to the mixed combustion control device 101. The sensor signal acquired by the mixed combustion control device 101 is, for example, a flow rate of the fuel, the air, the exhaust gas, or the like, a temperature of each of the units, a pressure, an output, a rotating speed, or a CO₂ concentration. In addition, the CO₂ recovery efficiency is a ratio of the CO₂ (108) to the sum of the CO₂ (109a) and the CO₂ (108). The CO₂ recovery efficiency may be replaced with, for example, a CO₂ recovery ratio.

### Configuration of Mixed Combustion Control Device

The mixed combustion control device 101 determines a mixed combustion ratio between the hydrogen or ammonia and the fossil fuel that are combusted by the combustion device 106, and controls combustion by the combustion device 106 such that one or a plurality of predetermined variables are optimized. The one or the plurality of predetermined variables include, for example, at least one among a power generation efficiency (energy efficiency), a power generation cost (energy cost), and a CO₂ recovery efficiency. In the present embodiment, the mixed combustion control device 101 determines the mixed combustion ratio, for example, using a trained machine learning model M1. In this case, for example, when the operating data output from the monitoring device 110 is input to the trained machine learning model M1, the mixed combustion control device 101 calculates and determines the mixed combustion ratio as an output of the trained machine learning model M1, and controls the valves 104 and 105 and the like to control the mixed combustion ratio.

In addition, the mixed combustion control device 101 notifies the determined mixed combustion ratio and the like to the hydrogen/ammonia supply device 102, combustion device 106, the exhaust gas after-treatment device 107, and the like. The mixed combustion ratio is a value representing a mixing ratio between the fossil fuel and the hydrogen or ammonia, and can be, for example, a ratio of the amount of heat in the hydrogen or ammonia to the total amount of heat in the fuel input to the combustion device 106. In the present embodiment, the mixed combustion control device 101 determines and controls the mixed combustion ratio, for example, according to the operating states of the hydrogen/ammonia supply device 102, the combustion device 106, the exhaust gas after-treatment device 107, and the like.

The combustion device 106 controls the mixed combustion ratio notified from the mixed combustion control device 101 in consideration of a power output, stable combustion, equipment lifetime, and the like. For example, when the mixed combustion ratio changes, a necessary air flow rate changes. In addition, desired combustion characteristics can be obtained based on fuel and an air flow rate. In the combustion device 106, for example, the air flow rate is controlled by a separate operation terminal for each of products, for example, based on the mixed combustion ratio, the fuel, and the desired combustion characteristic. In addition, when the hydrogen/ammonia supply device 102 includes the hydrogen/ammonia production device, a control of the production amount corresponding to the mixed combustion ratio is performed. The exhaust gas after-treatment device 107 performs a control of a process corresponding to an exhaust gas amount that changes depending on the mixed combustion ratio. One or a plurality of parameters controlled according to the mixed combustion ratio in the combustion device 106, the hydrogen/ammonia supply device 102, and the exhaust gas after-treatment device 107 are determined in the mixed combustion control device 101, for example, depending on the parameters output from the monitoring device 110. In this case, for example, a control linked with all of the combustion device 106, the hydrogen/ammonia supply device 102, and the exhaust gas after-treatment device 107 can be efficiently performed.

### Trained Machine Learning Model

FIGS. 2 to 4 illustrate three configuration examples of the trained machine learning model M1. FIGS. 2 to 4 illustrate a trained machine learning model M1-1 for power generation efficiency optimization control, a trained machine learning model M1-2 for power cost optimization control, and a trained machine learning model M1-3 for CO₂ recovery efficiency optimization control, respectively. The trained machine learning model M1 includes at least one among the trained machine learning model M1-1 for power generation efficiency optimization control, the trained machine learning model M1-2 for power cost optimization control, and the trained machine learning model M1-3 for CO₂ recovery efficiency optimization control.

The trained machine learning model M1-1 for power generation efficiency optimization control illustrated in FIG. 2 is a trained machine learning model that is machine-trained to output the mixed combustion ratio for optimizing the power generation efficiency when an input is a plurality of operating data 1-1, operating data 1-2, and . . . acquired in the mixed combustion system 1 and an output is the mixed combustion ratio. The trained machine learning model M1-1 for power generation efficiency optimization control is, for example, a trained model including a neural network as an element, in which a weighting coefficient between neurons of layers of the neural network is optimized by machine learning to output a solution that is acquired for a plurality of input data. The trained machine learning model M1-1 for power generation efficiency optimization control is configured with, for example, a combination of a program for performing an arithmetic operation from the input to the output and a weighting coefficient (parameter) used for the arithmetic operation. The trained machine learning model M1-1 for power generation efficiency optimization control is machine-trained by using, as training data, learning data including a set of a plurality of operating data 1-1, operating data 1-2, and . . . (input) and a mixed combustion ratio (output), for example, when a power generation efficiency obtained from past operational experience or a virtual operation or the like using a simulator is relatively high (for example, the power generation efficiency is higher than a predetermined threshold value). In this case, the power generation efficiency is a ratio of an output energy (generated power) to an input energy (chemical energy in the fuel).

The trained machine learning model M1-2 for power cost optimization control and the trained machine learning model M1-3 for CO₂ recovery efficiency optimization control can also be configured as the same model as the trained machine learning model M1-1 for power generation efficiency optimization control. In addition, the operating data 1-1, the operating data 1-2, and . . . that are the input data of the trained machine learning model M1-1 for power generation efficiency optimization control include, for example, data such as a generator output, a fuel consumption used for efficiency calculation, or a fuel lower heating value.

The trained machine learning model M1-2 for power cost optimization control illustrated in FIG. 3 is a trained machine learning model that is machine-trained to output the mixed combustion ratio for optimizing the power generation cost (=power generation unit price) when an input is a plurality of operating data 2-1, operating data 2-2, and . . . acquired in the mixed combustion system 1 and an output is the mixed combustion ratio. Regarding the power generation cost, a procurement cost for production, transport, storage, and the like of hydrogen/ammonia is also considered. Further, since a device maintenance cost is also considered for the cost, it is also effective to consider the influence of a change in mixed combustion ratio on the component lifetime. The trained machine learning model M1-2 for power cost optimization control is machine-trained by using, as training data, learning data including a set of a plurality of operating data 2-1, operating data 2-2, and . . . (input) and a mixed combustion ratio (output), for example, when a power generation cost obtained from past operational experience or a virtual operation or the like using a simulator is relatively low (for example, the power generation cost is lower than a predetermined threshold value). In addition, the operating data 2-1, the operating data 2-2, and . . . that are the input data of the trained machine learning model M1-2 for power cost optimization control include, for example, data such as a generator output or a fuel cost used for power generation cost calculation.

The trained machine learning model M1-3 for CO₂ recovery efficiency optimization control illustrated in FIG. 4 is a trained machine learning model that is machine-trained to output the mixed combustion ratio for optimizing the CO₂ recovery efficiency when an input is a plurality of operating data 3-1, operating data 3-2, and . . . acquired in the mixed combustion system 1 and an output is the mixed combustion ratio. The trained machine learning model M1-3 for CO₂ recovery efficiency optimization control is machine-trained by using, as training data, learning data including a set of a plurality of operating data 3-1, operating data 3-2, and . . . (input) and a mixed combustion ratio (output), for example, when a CO₂ recovery efficiency obtained from past operational experience or a virtual operation or the like using a simulator is relatively high (for example, the CO₂ recovery efficiency is higher than a predetermined threshold value). In addition, the operating data 3-1, the operating data 3-2, and . . . that are the input data of the trained machine learning model M1-3 for CO₂ recovery efficiency optimization control include, for example, data such as a generator output, CO₂ emissions used for calculation of the CO₂ recovery efficiency, or a CO₂ recovery amount. The data representing the generator output is an example of data representing an output energy generated by mixed combustion from the combustion device according to the present disclosure. In addition, the data representing the CO₂ recovery amount (or the CO₂ emissions and the CO₂ recovery amount) is an example of data representing a receiving state of the carbon dioxide recovery device according to the present disclosure.

The trained machine learning model M1-1 for power generation efficiency optimization control is a configuration example of the trained machine learning model for energy efficiency optimization control that is machine-trained to output the mixed combustion ratio for optimizing the energy efficiency when an input is a plurality of operating data acquired in the mixed combustion system according to the present disclosure and an output is the mixed combustion ratio. Here, the energy efficiency is a ratio of an output energy (converted energy or the like) to an input energy. In addition, the trained machine learning model M1-2 for power cost optimization control is a configuration example of the trained machine learning model for energy cost optimization control that is machine-trained to output the mixed combustion ratio for optimizing the energy cost (cost per unit output energy) when an input is a plurality of operating data acquired in the mixed combustion system according to the present disclosure and an output is the mixed combustion ratio. The trained machine learning model M1-3 for CO₂ recovery efficiency optimization control is a configuration example of the trained machine learning model for carbon dioxide recovery efficiency optimization control that is machine-trained to output the mixed combustion ratio for optimizing the carbon dioxide recovery efficiency of the carbon dioxide recovery device when an input is a plurality of operating data acquired in the mixed combustion system according to the present disclosure and an output is the mixed combustion ratio.

### Operation Example of Mixed Combustion Control Device

FIG. 5 illustrates an operation example of the mixed combustion control device 101. The mixed combustion control device 101 can selectively use, as the trained machine learning model M1, at least one among the trained machine learning model M1-1 for power generation efficiency optimization control, the trained machine learning model M1-2 for power cost optimization control, and the trained machine learning model M1-3 for CO₂ recovery efficiency optimization control. In addition, in this example, the trained machine learning model M1-2 for power cost optimization control is a selection model of an initial setting. In addition, In the mixed combustion system 1, a predetermined lower limit value is set for the CO₂ recovery efficiency. In this operation example, the mixed combustion control device 101 determines the mixed combustion ratio such that the cost or the efficiency is optimized using the trained machine learning model M1-1 for power generation efficiency optimization control, or the trained machine learning model M1-2 for power cost optimization control, for example, during a stable operation. In addition, for example, when the gas turbine power generation device is quickly started for a rapid response to a demand for power feeding, the mixed combustion control device 101 determines the mixed combustion ratio to optimize the CO₂ recovery efficiency using the trained machine learning model M1-3 for CO₂ recovery efficiency optimization control. When the start of the CO₂ recovery device 1071 is slower than the start of the gas turbine power generation device, it is assumed that the CO₂ recovery efficiency decreases for a given period of time. The start of the CO₂ recovery device is an example of data representing the receiving state. Therefore, for example, when the gas turbine power generation device is quickly started, the mixed combustion control device 101 maintains the CO₂ recovery efficiency using the trained machine learning model M1-3 for CO₂ recovery efficiency optimization control.

The process illustrated in FIG. 5 is started, for example, according to an instruction of an operator. First, the mixed combustion control device 101 selects the trained machine learning model M1-2 for power cost optimization control (Step S11). Hereinafter, the mixed combustion control device 101 controls the mixed combustion ratio using the trained machine learning model M1 selected in Step S1 (Step S2). In addition, the mixed combustion control device 101 regularly determines whether or not a change in the trained model is necessary (Step S3). When a change in the trained model is necessary, in this example, when a model other than the trained machine learning model M1-3 for CO₂ recovery efficiency optimization control is used, the CO₂ recovery efficiency may fall below the lower limit value. Alternatively, when a change in the trained model is necessary, for example, when the trained machine learning model M1-3 for CO₂ recovery efficiency optimization control is used, the CO₂ recovery efficiency may sufficiently exceed the lower limit value.

On the other hand, in a case where a change in the trained model is necessary (Step S3: YES), when the trained machine learning model M1-3 for CO₂ recovery efficiency optimization control is not used, the mixed combustion control device 101 selects the trained machine learning model M1-3 for CO₂ recovery efficiency optimization control (Step S1), and when the trained machine learning model M1-3 for CO₂ recovery efficiency optimization control is used, the mixed combustion control device 101 selects a model other than the trained machine learning model M1-3 for CO₂ recovery efficiency optimization control (Step S1). Hereinafter, the mixed combustion control device 101 controls the mixed combustion ratio using the trained machine learning model M1 selected in Step S1 (Step S2). In addition, the mixed combustion control device 101 regularly determines whether or not a change in the trained model is necessary (Step S3).

On the other hand, when a change in the trained model is not necessary (Step S3: NO), the mixed combustion control device 101 determines whether or not to end the control of the mixed combustion ratio (Step S4). When the control of the mixed combustion ratio ends, for example, the operation of the combustion device 106 may stop. When the control of the mixed combustion ratio ends (Step S4: YES), the mixed combustion control device 101 ends the process illustrated in FIG. 5. When the control of the mixed combustion ratio does not end (Step S4: NO), the mixed combustion control device 101 regularly determines whether or not a change in the trained model is necessary (Step S3).

The operation example illustrated in FIG. 5 is one operation example of the mixed combustion control device 101, and the operation of the mixed combustion control device 101 is not limited to the operation example illustrated in FIG. 5. For example, three mixed combustion ratios may be acquired in parallel using the three learning models including the trained machine learning model M1-1 for power generation efficiency optimization control, the trained machine learning model M1-2 for power cost optimization control, and the trained machine learning model M1-3 for CO₂ recovery efficiency optimization control to determine a calculated value such as a maximum mixed combustion ratio or an average value as the mixed combustion ratio based on two or three mixed combustion ratios. When the calculated value based on two or three mixed combustion ratios is used, the mixed combustion ratio is determined to optimize a plurality of variables.

### Operations and Effects and the Like

In the mixed combustion system, the mixed combustion control device, and the mixed combustion control method having the above-described configuration, a mixed combustion ratio between the hydrogen or ammonia and the fossil fuel that are combusted by the combustion device 106 is determined, and the combustion by the combustion device 106 is controlled such that at least one among an energy efficiency (power generation efficiency), an energy cost (power generation cost), and a carbon dioxide recovery efficiency is optimized. Accordingly, with the mixed combustion system, the mixed combustion control device, and the mixed combustion control method according to the embodiment, the mixed combustion ratio can be appropriately controlled.

As described above, with the present embodiment, the mixed combustion ratio between the decarbonization fuel (hydrogen or ammonia) and the fuel in the related art can be changed depending on the operating state. In addition, in the present embodiment, for example, the respective processes of the hydrogen supply, the power generation, and the gas treatment are integrally controlled, and an operation corresponding to the decarbonization target can be performed. In addition, as a constraint condition for the operation optimization, CO₂ emissions in the entire value chain such as fuel production may also be considered.

In addition, in the present embodiment, when the CO₂ recovery device requires, for example, waste heat from the power generation facility, a period of time is required until CO₂ can be recovered from the start. When the power generation facility needs to be operated to be quickly started according to a power demand. In this case, an increase in the utilization ratio of the decarbonization fuel is means for achieving the decarbonization. In addition, during a steady operation, the power generation facility can operate at a mixed combustion ratio that is determined based on a balance such as a cost ratio between the decarbonization fuel and the fossil fuel or a CO₂ recovery cost. In addition, the effect is maximized by grasping the prediction and experience of the effect in a combination of a plurality of means such as hydrogen and ammonia combustion and CO₂ recovery as the decarbonization technology.

### Other Embodiments

Above, the embodiments of the present disclosure have been described in detail with reference to the drawings, but the specific configuration is not limited to the embodiments, and includes design changes and the like within a scope not departing from the gist of the present disclosure.

### Configuration of Computer

FIG. 6 illustrates a configuration of a computer according to the embodiment of the present disclosure.

A computer 90 includes a processor 91, a main memory 92, a storage 93, and an interface 94.

The above-described mixed combustion control device 101 is mounted on the computer 90. The operation of each processing unit described above is stored in the storage 93 in the form of a program. The processor 91 reads the program from the storage 93, deploys the program in the main memory 92, and executes the above-described processing according to the program. In addition, the processor 91 allocates a storage area corresponding to each storage unit described above in the main memory 92 according to the program.

The program may be for realizing some of the functions to be exhibited by the computer 90. For example, the program may exhibit a function in combination with another program already stored in a storage or in combination with another program implemented in another device. In another embodiment, the computer may include a custom large scale integrated (LSI) circuit such as a programmable logic device (PLD) in addition to or instead of the above configuration. Examples of the PLD include a programmable array logic (PAL), a generic array logic (GAL), a complex programmable logic device (CPLD), and a field programmable gate array (FPGA). In this case, some or all of the functions realized by the processor may be realized by the integrated circuit.

Examples of the storage 93 include a hard disk drive (HDD), a solid state drive (SSD), a magnetic disk, a magneto-optical disk, a compact disc read only memory (CD-ROM), a digital versatile disc read only memory (DVD-ROM), and a semiconductor memory. The storage 93 may be an internal medium directly connected to a bus of the computer 90, or may be an external medium connected to the computer 90 via the interface 94 or a communication line. In addition, when this program is distributed to the computer 90 via the communication line, the computer 90 that has received the distribution may develop the program in the main memory 92, and may execute the above-described processing. In at least one embodiment, the storage 93 is a non-transitory tangible storage medium.

### Supplementary Notes

The mixed combustion system 1 according to the above-described embodiment is understood as follows, for example.

(1) According to a first aspect, there is provided a mixed combustion system 1 including: a combustion device 106 configured to mix and combust hydrogen or ammonia and fossil fuel; an exhaust gas after-treatment device 107 configured to treat exhaust gas of the combustion device 106; and a mixed combustion control device 101 configured to determine a mixed combustion ratio between the hydrogen or ammonia and the fossil fuel that are combusted by the combustion device 106 and to control the combustion by the combustion device such that one or a plurality of predetermined variables are optimized, in which the one or the plurality of variables include at least one among an energy efficiency (a power generation efficiency or the like), an energy cost (a power generation cost or the like), and a carbon dioxide recovery efficiency. According to the present aspect and each of the following aspects, the mixed combustion ratio can be appropriately controlled.

(2) A mixed combustion system 1 according to a second aspect is the mixed combustion system 1 according to (1), the exhaust gas after-treatment device includes a carbon dioxide recovery device (CO₂ recovery device 1071).

(3) A mixed combustion system 1 according to a third aspect is the mixed combustion system 1 according to (2), the mixed combustion control device 101 determines the mixed combustion ratio using at least one among a trained machine learning model for energy efficiency optimization control (trained machine learning model M1-1 for power generation efficiency optimization control) that is machine-trained to output the mixed combustion ratio for optimizing the energy efficiency when an input is a plurality of operating data acquired by the mixed combustion system and an output is the mixed combustion ratio, a trained machine learning model for energy cost optimization control (trained machine learning model M1-2 for power cost optimization control) that is machine-trained to output the mixed combustion ratio for optimizing the energy cost when an input is a plurality of operating data acquired by the mixed combustion system and an output is the mixed combustion ratio, and a trained machine learning model for carbon dioxide recovery efficiency optimization control (trained machine learning model M1-3 for CO₂ recovery efficiency optimization control) that is machine-trained to output the mixed combustion ratio for optimizing the carbon dioxide recovery efficiency of the carbon dioxide recovery device when an input is a plurality of operating data acquired by the mixed combustion system and an output is the mixed combustion ratio.

(4) A mixed combustion system 1 according to a fourth aspect is the mixed combustion system 1 according to (1) to (3), in which the plurality of operating data include at least data representing an output energy (a generator output or the like) generated by mixed combustion from the combustion device.

(5) A mixed combustion system 1 according to a fifth aspect is the mixed combustion system 1 according to (4), the plurality of operating data further include at least data representing a receiving state of the carbon dioxide recovery device (a CO₂ recovery amount, CO₂ emissions, a CO₂ recovery amount, or the like).

### Industrial Applicability

According to the above-described one aspect, the mixed combustion ratio can be appropriately controlled.

### REFERENCE SIGNS LIST

1: mixed combustion system
101: mixed combustion control device
102: hydrogen/ammonia supply device
103: fossil fuel supply device
104, 105: valve
106: combustion device
107: exhaust gas after-treatment device
110: monitoring device
1071: CO₂ recovery device
M1: trained machine learning model
M1-1: trained machine learning model for power generation efficiency optimization control
M1-2: trained machine learning model for power generation cost optimization control
M1-3: trained machine learning model for CO₂ recovery efficiency optimization control

1. A mixed combustion system comprising:
a combustion device configured to mix and combust hydrogen or ammonia and fossil fuel;
an exhaust gas after-treatment device configured to treat exhaust gas of the combustion device; and
a mixed combustion control device configured to determine a mixed combustion ratio between the hydrogen or ammonia and the fossil fuel that are combusted by the combustion device and to control the combustion by the combustion device such that one or a plurality of predetermined variables are optimized, wherein
the one or the plurality of variables include at least one among an energy efficiency, an energy cost, and a carbon dioxide recovery efficiency,
the exhaust gas after-treatment device includes a carbon dioxide recovery device, and
the mixed combustion control device determines the mixed combustion ratio using at least one among
a trained machine learning model for energy efficiency optimization control that is machine-trained to output the mixed combustion ratio for optimizing the energy efficiency when an input is a plurality of operating data acquired by the mixed combustion system and an output is the mixed combustion ratio,
a trained machine learning model for energy cost optimization control that is machine-trained to output the mixed combustion ratio for optimizing the energy cost when an input is a plurality of operating data acquired by the mixed combustion system and an output is the mixed combustion ratio, and
a trained machine learning model for carbon dioxide recovery efficiency optimization control that is machine-trained to output the mixed combustion ratio for optimizing the carbon dioxide recovery efficiency of the carbon dioxide recovery device when an input is a plurality of operating data acquired by the mixed combustion system and an output is the mixed combustion ratio.

2-3. (canceled)

4. The mixed combustion system according to claim 1, wherein the plurality of operating data include at least data representing an output energy generated by mixed combustion from the combustion device.

5. The mixed combustion system according to claim 4, wherein the plurality of operating data further include at least data representing a receiving state of the carbon dioxide recovery device.

6. A mixed combustion control device, wherein
in a mixed combustion system including a combustion device configured to mix and combust hydrogen or ammonia and fossil fuel, and an exhaust gas after-treatment device configured to treat exhaust gas of the combustion device, the mixed combustion control device determines a mixed combustion ratio between the hydrogen or ammonia and the fossil fuel that are combusted by the combustion device and controls the combustion by the combustion device such that at least one among an energy efficiency, an energy cost, and a carbon dioxide recovery efficiency is optimized,
the exhaust gas after-treatment device includes a carbon dioxide recovery device, and
the mixed combustion control device determines the mixed combustion ratio using at least one among
a trained machine learning model for energy efficiency optimization control that is machine-trained to output the mixed combustion ratio for optimizing the energy efficiency when an input is a plurality of operating data acquired by the mixed combustion system and an output is the mixed combustion ratio,
a trained machine learning model for energy cost optimization control that is machine-trained to output the mixed combustion ratio for optimizing the energy cost when an input is a plurality of operating data acquired by the mixed combustion system and an output is the mixed combustion ratio, and
a trained machine learning model for carbon dioxide recovery efficiency optimization control that is machine-trained to output the mixed combustion ratio for optimizing the carbon dioxide recovery efficiency of the carbon dioxide recovery device when an input is a plurality of operating data acquired by the mixed combustion system and an output is the mixed combustion ratio.

7. A mixed combustion control method performed in a mixed combustion system including a combustion device configured to mix and combust hydrogen or ammonia and fossil fuel, and an exhaust gas after-treatment device configured to treat exhaust gas of the combustion device, the method comprising:
determining a mixed combustion ratio between the hydrogen or ammonia and the fossil fuel that are combusted by the combustion device and controlling the combustion by the combustion device such that at least one among an energy efficiency, an energy cost, and a carbon dioxide recovery efficiency is optimized, wherein
the exhaust gas after-treatment device includes a carbon dioxide recovery device, and
the determining the mixed combustion ratio includes determining the mixed combustion ratio using at least one among
a trained machine learning model for energy efficiency optimization control that is machine-trained to output the mixed combustion ratio for optimizing the energy efficiency when an input is a plurality of operating data acquired by the mixed combustion system and an output is the mixed combustion ratio,
a trained machine learning model for energy cost optimization control that is machine-trained to output the mixed combustion ratio for optimizing the energy cost when an input is a plurality of operating data acquired by the mixed combustion system and an output is the mixed combustion ratio, and
a trained machine learning model for carbon dioxide recovery efficiency optimization control that is machine-trained to output the mixed combustion ratio for optimizing the carbon dioxide recovery efficiency of the carbon dioxide recovery device when an input is a plurality of operating data acquired by the mixed combustion system and an output is the mixed combustion ratio.
